(19) United States
(12) Patent Application Publication
(10) Pub. No.: US 2020/0085239 A1
(43) Pub. Date: Mar. 19, 2020

(54) Pan

(71) Applicant: KATZ HORIZONS LLC, Westlake Village, CA (US)

(72) Inventor: Marc Katz, Westlake Village, CA (US)

(73) Assignee: Katz Horizons LLC, Weslake Village, CA (US)

(21) Appl. No.: 16/572,986

(22) Filed: Sep. 17, 2019

Related U.S. Application Data
(60) Provisional application No. 62/732,835, filed on Sep. 18, 2018.

(51) Int. Cl. A47J 37/10

(52) U.S. Cl. CPC A47J 37/10

(57) ABSTRACT

A flip-assisted frying pan that aids a user while flipping food while cooking with the pan. The present invention evenly heats food while resting on a heated stove top. The present invention effectively directs the path of food being flipped or tossed back onto the pan. In order to contain food within the pan while flipping food with the present invention, the present invention comprises at least one handle, a body, a guiding lip, and a rim.

### CROSS REFERENCE PARAGRAPH

This U.S. Non-Provisional patent application claims priority to and the benefit of U.S. Provisional Patent Application No. 62/732,835, filed on Sep. 18, 2018, titled “Flip-Assisted Frying Pan”, by inventor Marc Katz, the contents of which are expressly incorporated herein by this reference as though set forth in their entirety.

### FIELD OF USE

The present disclosure relates to cooking pans. More specifically, the present disclosure relates to a flip-assisted frying pan that shields food contained within the pan from escaping while being flipped or tossed by a user.

### BACKGROUND

Timing is essential to cooking. In order to complete each step of a recipe in a timely fashion, an individual must become comfortable performing a variety of tricks. One such trick that is difficult to master is flipping food in a frying pan by simply tossing the food within the frying pan into the air and back onto the frying pan. The individual maneuvers the handle such that the food is tossed into the air and flips back onto the pan. This allows the food within the frying pan to be evenly heated along all side and allows individual cooking to efficiently flip the food within the frying pan. The hardest part about flipping food within the frying pan is directing the food back onto the pan while in midair. This difficulty results from the consistent height of the pan across an opening of the pan. The lack of a push against the food towards the frying pan forces an individual to react quickly and with precision in order to catch the flipping food. It is therefore an objective of the present invention to direct food back onto the pan while being flipped with only the present invention. The present invention comprises a guiding lip that physically pushes the food back towards the frying pan while flipping in midair. The present invention ensures that food within the frying pan always remains within the frying pan. The present invention eliminates or significantly lessens the mess as a result of flipping food with solely a frying pan.

### BRIEF DESCRIPTION OF THE DRAWINGS

FIG. 1 is a perspective view of the present invention.

FIG. 2 is a front side view of the present invention.

FIG. 3 is a front view of an alternate embodiment of the present invention with a supplementary handle.

FIG. 4 is a top side view of the present invention.

FIG. 5 is a top side view of the alternate embodiment of the present invention with the supplementary handle.

FIG. 6 is a schematic view of a plurality of layers for a body of the preferred embodiment for the present invention.

FIG. 7 is a top perspective view of one embodiment of a pan.

FIG. 8 is a right side elevational view thereof.

FIG. 9 is a left side elevational view thereof.

FIG. 10 is a top plan view thereof.

FIG. 11 is a bottom plan view thereof.

FIG. 12 is a rear elevational view thereof.

FIG. 13 is a front elevational view thereof.

FIG. 14 is top perspective view of another embodiment of a pan.

FIG. 15 is top perspective view of another embodiment of a pan.

FIG. 16 is bottom perspective view of another embodiment of a pan.

### DETAILED DESCRIPTION

Before the present methods and systems are disclosed and described, it is to be understood that the methods and systems are not limited to specific methods, specific components, or to particular implementations. The methods and systems disclosed and described herein may be understood more readily by reference to the following detailed description of preferred embodiments and the examples included therein and to the Figures and their previous and following description. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item or result.

As used herein, the terms “approximately” and “about” generally refer to a deviance of within 5% of the indicated number or range of numbers. In one embodiment, the term “approximately” and “about” may refer to a deviance of between 0.001-10% from the indicated number or range of numbers. Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

Before the present methods and systems are disclosed and described in detail, it is to be understood that the methods and systems are not limited to specific methods, specific components, or to particular implementations. It is also to be understood that the terminology used herein is for the purpose of describing particular embodiments only and is not intended to be limiting.

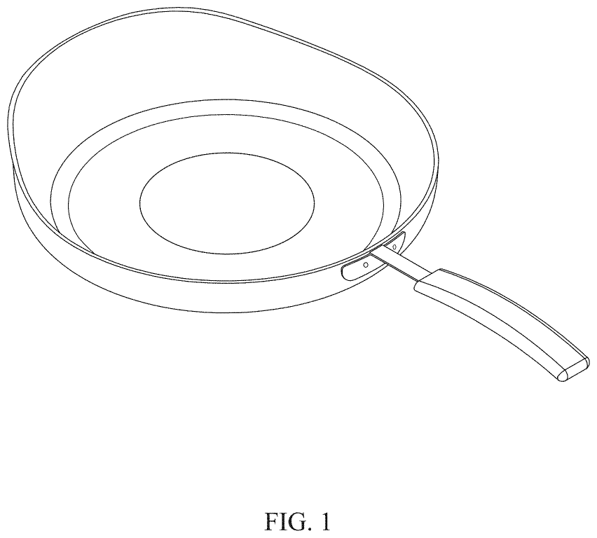

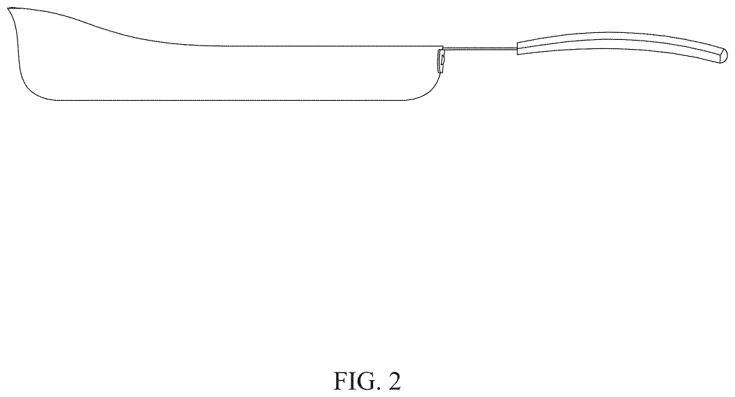

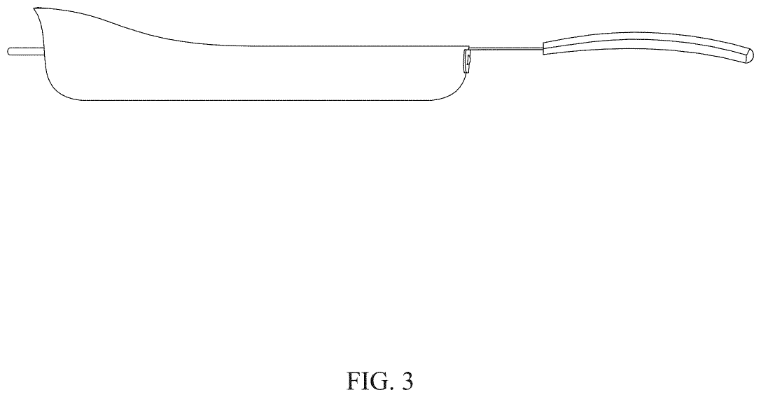

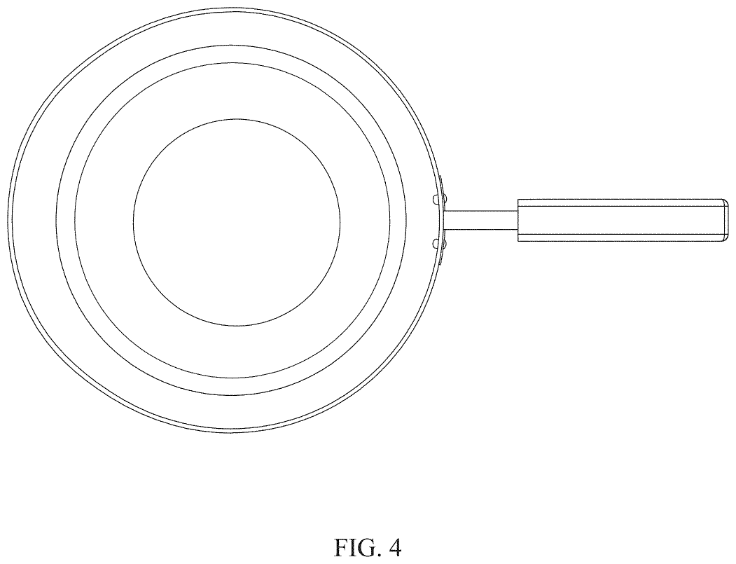

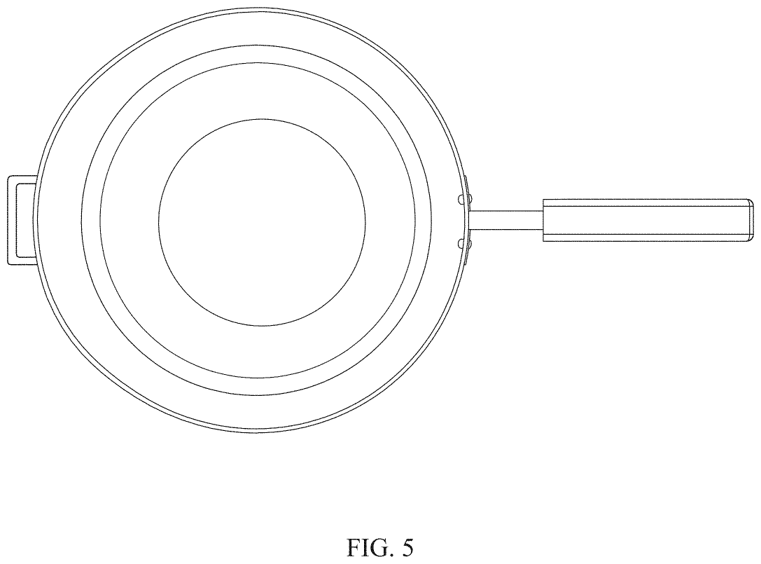

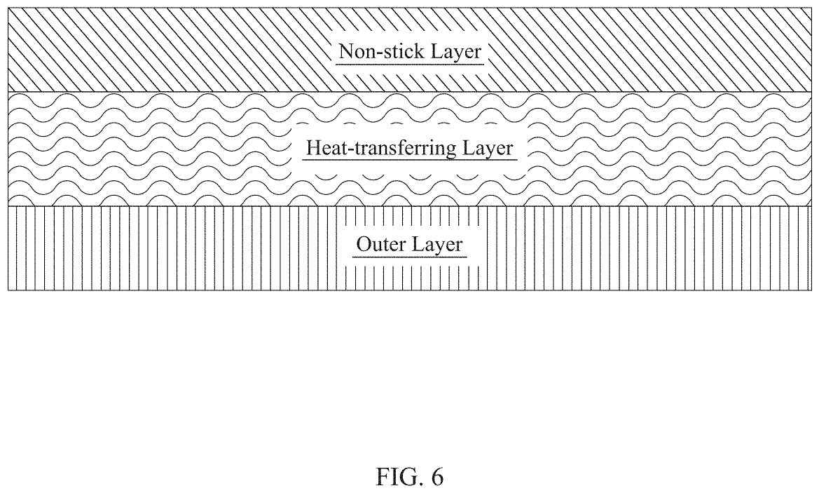

The present invention is a flip-assisted frying pan that aids a user while flipping food with the present invention. The present invention evenly heats food while resting on a heated stove top. The present invention effectively directs the path of food being flipped to back onto the present invention. In order to contain food within the present invention while flipping food with the present invention, the present invention comprises at least one handle, a body, a guiding lip, and a rim, seen in FIG. 1. The user is able to maneuver the body without getting burned by the body with the at least one handle. The body transfers heat from a heated stovetop to food contained within the body. Moreover, the body contains and heats food. The body comprises a first base plate and a first side wall. The first base plate upholds food from the stovetop and transfers the heat from the stovetop to the food and the first side wall. The first side wall contains the food on top of the first base plate. The guiding lip shields the food from escaping past the first side wall while being flipped. The rim defines the perimeter of the body. The overall configuration of the aforementioned components allows the present invention to contain food while flipping food. The first side wall is perimetrically fixed to the first base plate and is oriented perpendicular to the first base plate, shown in FIG. 2 and FIG. 3. This arrangement surrounds food resting on the first base plate. A first edge of the guiding lip being fixed across the first side wall, positioned opposite the first base plate. A second edge of the guiding lip being positioned opposite the first edge across the guiding lip. An apex of the guiding lip is positioned along the second edge of the guiding lip. The overall structure of the guiding lip maximizes the support and coverage for food being flipped without adding too much weight to the body. The rim traverses across the first side wall and the second edge of the guiding lip. Moreover, the rim is positioned opposite the first base plate across the first side wall and the guiding lip. The at least one handle is externally mounted to the first side wall. The at least one handle is oriented perpendicular to the first base plate. The body preferably comprises a plurality of layers that evenly distribute and facilitate the transfer of heat. The plurality of layers preferably comprises a non-stick layer, a heat-transferring layer, and an outer layer, shown in FIG. 6. The heat-transferring layer is positioned in between the non-stick layer and the outer layer. The non-stick layer, the heat-transferring layer, and the outer layer are co-extensive with each other. Moreover, the non-stick layer, the heat-transferring layer, and the outer layer traverse across the first base plate, the first side wall, and the guiding lip. This arrangement allows food within the body to be evenly cooked regardless of the position of the food within the pan. The at least one handle is positioned adjacent the outer layer, thereby positioning the outer layer adjacent a stovetop. In alternate embodiments of the present invention, a core of the first base plate comprises a plurality of heat-transferring layers. The preferred embodiment of the present invention comprises a mounting plate and a couple of rivets, seen in FIG. 1, FIG. 2, FIG. 3, FIG. 4, and FIG. 5. The mounting plate connects the at least one handle to the first side wall. Moreover, the mounting plate structurally reinforces the connection between the at least one handle and the first side wall by increasing the area of contact of the at least one handle with the first side wall.

The couple of rivets connects the mounting plate and the first side wall. The mounting plate is positioned in between the at least one handle and the first side wall. The at least one handle is laterally fixed to the mounting plate and is centrally positioned along the mounting plate. The mounting plate laterally traverses across the first side wall and is mounted to the first side wall with the couple of rivets. The at least one handle is 5

positioned in between the couple of rivets. In alternate embodiments of the present invention, a couple of stabilizing rods may connect the at least one handle to the mounting plate. The couple of stabilizing rods is terminally fixed to the at least one handle. The mounting plate is fixed to the couple of stabilizing rods, positioned opposite the at least one handle. Each of the couple of stabilizing rods is oriented at an acute angle with the at least one handle. The orientation of the couple of stabilizing rods with the mounting plate and the at least one handle requires the user to apply less force while balancing the weight of the body and the weight of the food with the at least one handle. It is understood that alternate embodiments of the present invention may comprise a mounting plate that is fixed to the side wall with a variety of fasteners. Moreover, alternate embodiments of the present invention may comprise a mounting plate that is directly welded with the side wall. In order for a user to grab the handle without getting burned, the present invention preferably comprises a sleeve, seen in FIG. 1, FIG. 2, FIG. 3, FIG. 4, and FIG. 5. The sleeve inhibits the transfer of heat to the hand of the user. The sleeve is mounted to the handle, positioned opposite the body. The sleeve may also comprise a friction-inducing layer that further reinforces the grip of the user around the handle. Alternate embodiments of the present invention may comprise a supplementary handle, seen in FIG. 3 and FIG. 5. The supplementary handle aids the user in balancing and maneuvering the body. The supplementary handle is externally mounted to the first side wall, opposite the at least one handle. Alternate embodiments of the present invention may further comprise a cover. The cover seals an opening of the body. The opening of the body is defined by the rim. The cover contains any oil or food that may splatter past the rim. The cover comprises a second base plate, a second side wall, and a main handle. The second side wall is 30 perimetrically fixed to the second base plate and is oriented perpendicular to the second base plate. This arrangement elevates the second base plate above the opening of the body. The main handle is mounted onto the second base plate, positioned opposite the second side wall, allowing the user to maneuver the cover without getting burned. A first edge of the second side wall is positioned adjacent the rim. The first edge of the second side wall is positioned opposite the second base plate. The rim is flushed with the first edge of the side wall in order to contain the contents within the body. It is understood that the first edge of the second side wall comprises the structure that contours to the structure of the rim.

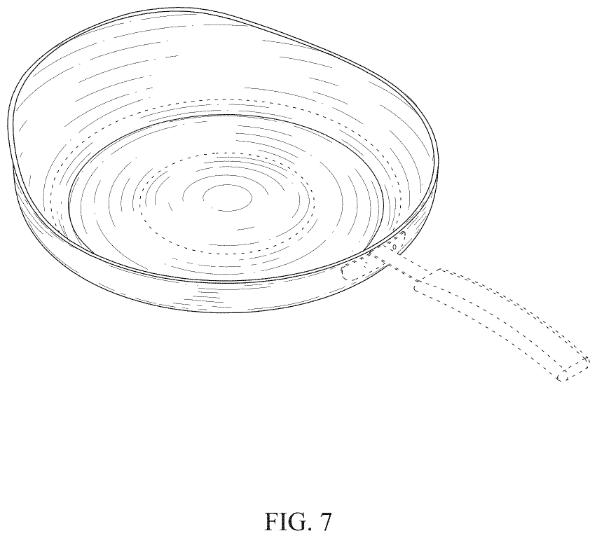

FIG. 7 is a top perspective view of one embodiment of a pan.

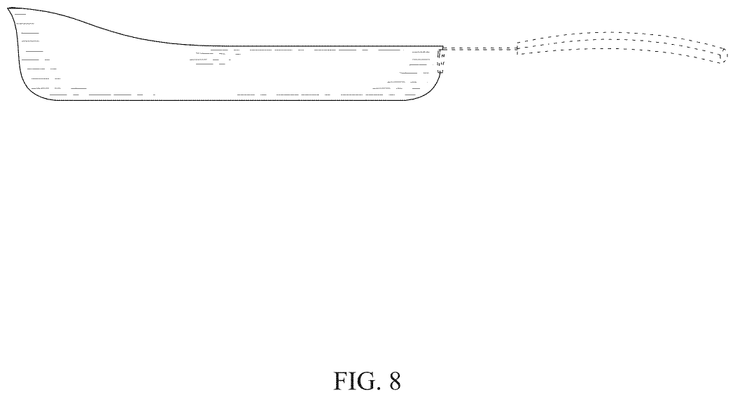

FIG. 8 is a right side elevational view thereof.

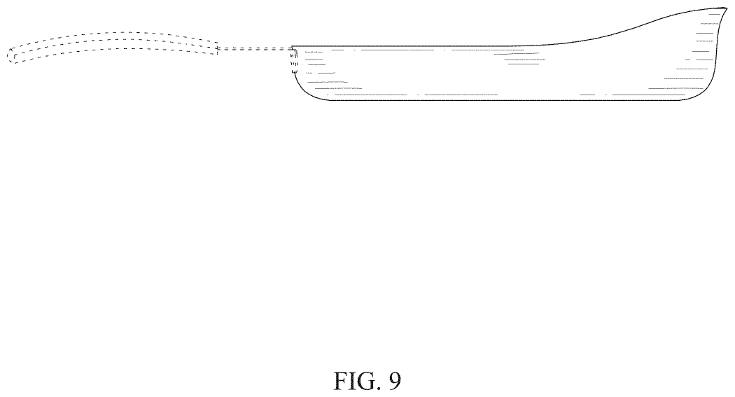

FIG. 9 is a left side elevational view thereof.

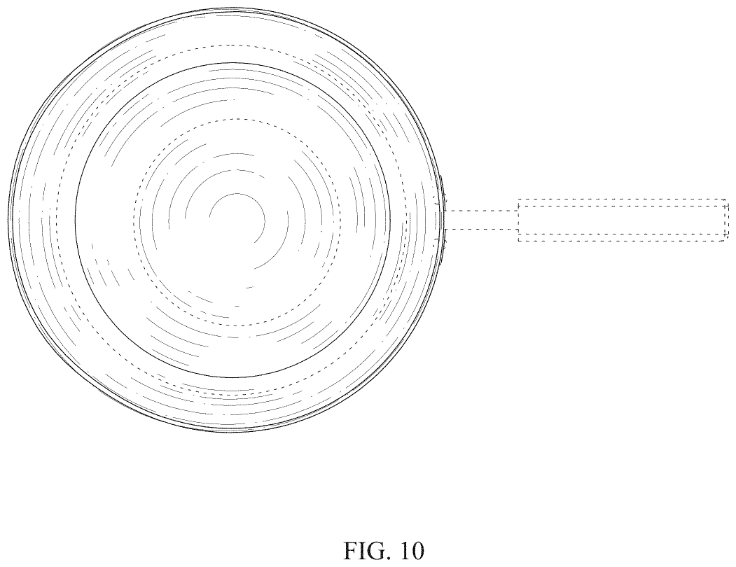

FIG. 10 is a top plan view thereof.

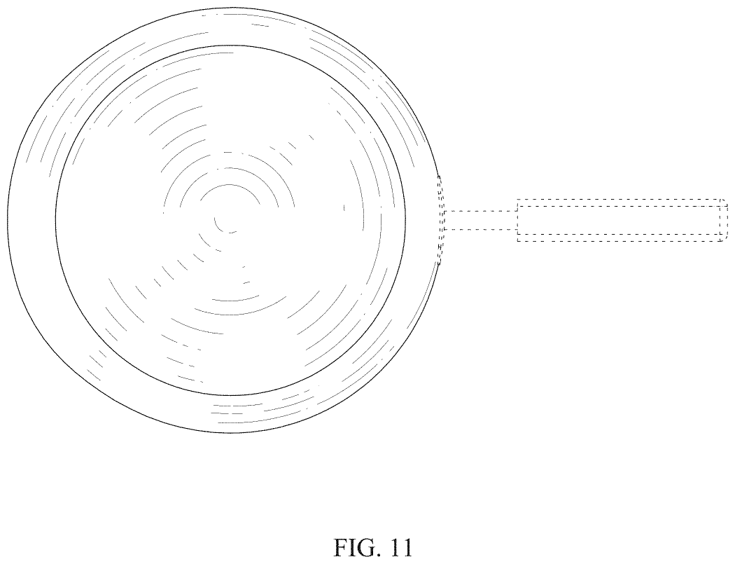

FIG. 11 is a bottom plan view thereof.

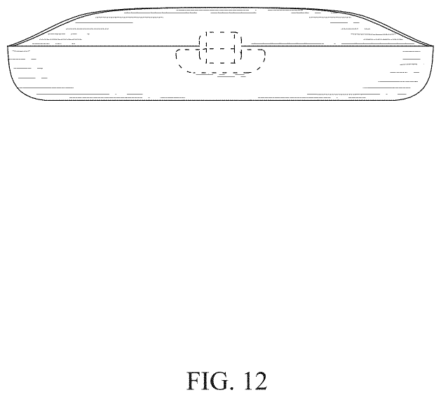

FIG. 12 is a rear elevational view thereof.

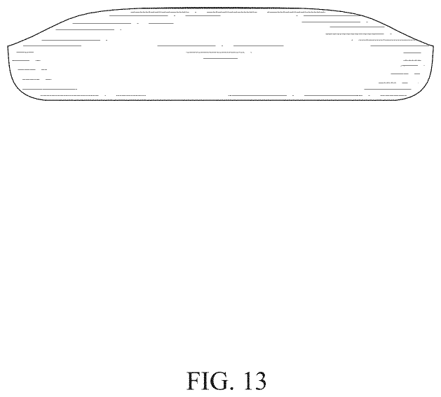

FIG. 13 is a front elevational view thereof.

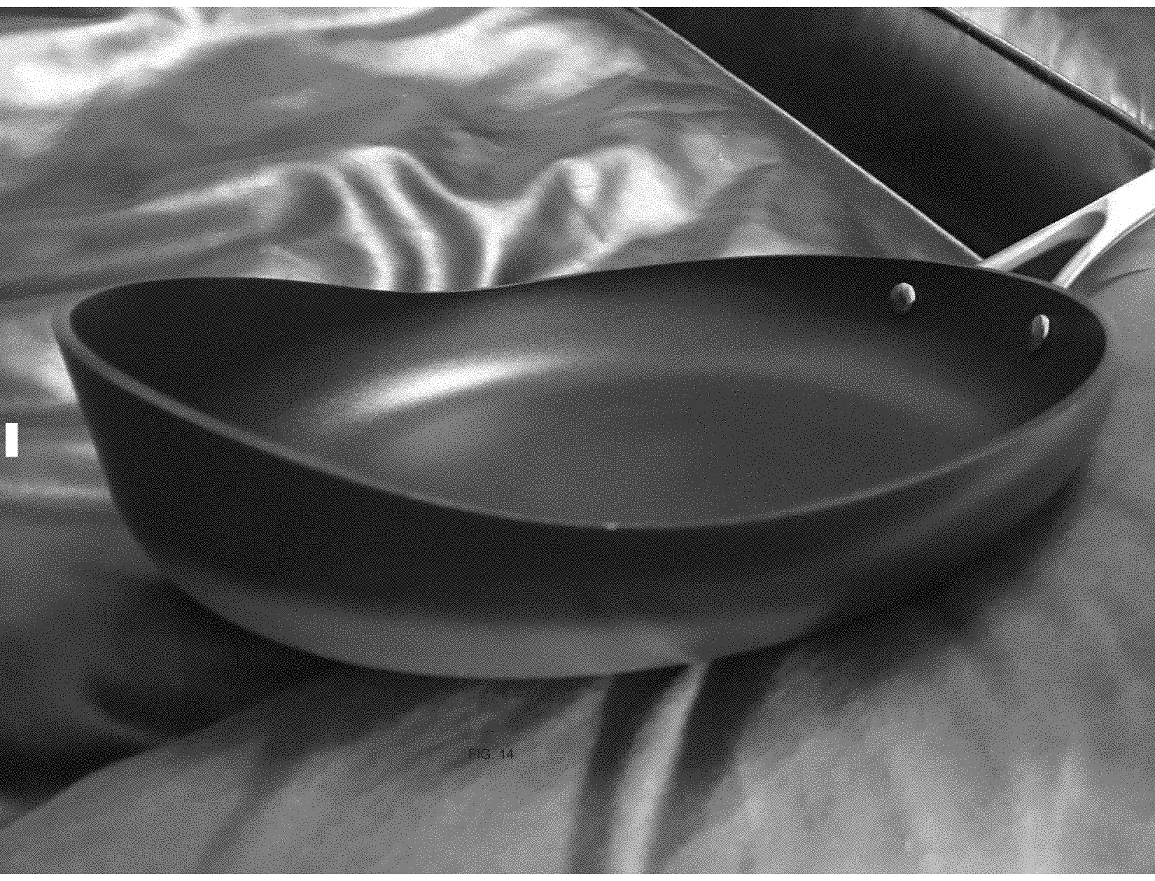

FIG. 14 is top perspective view of another embodiment of a pan.

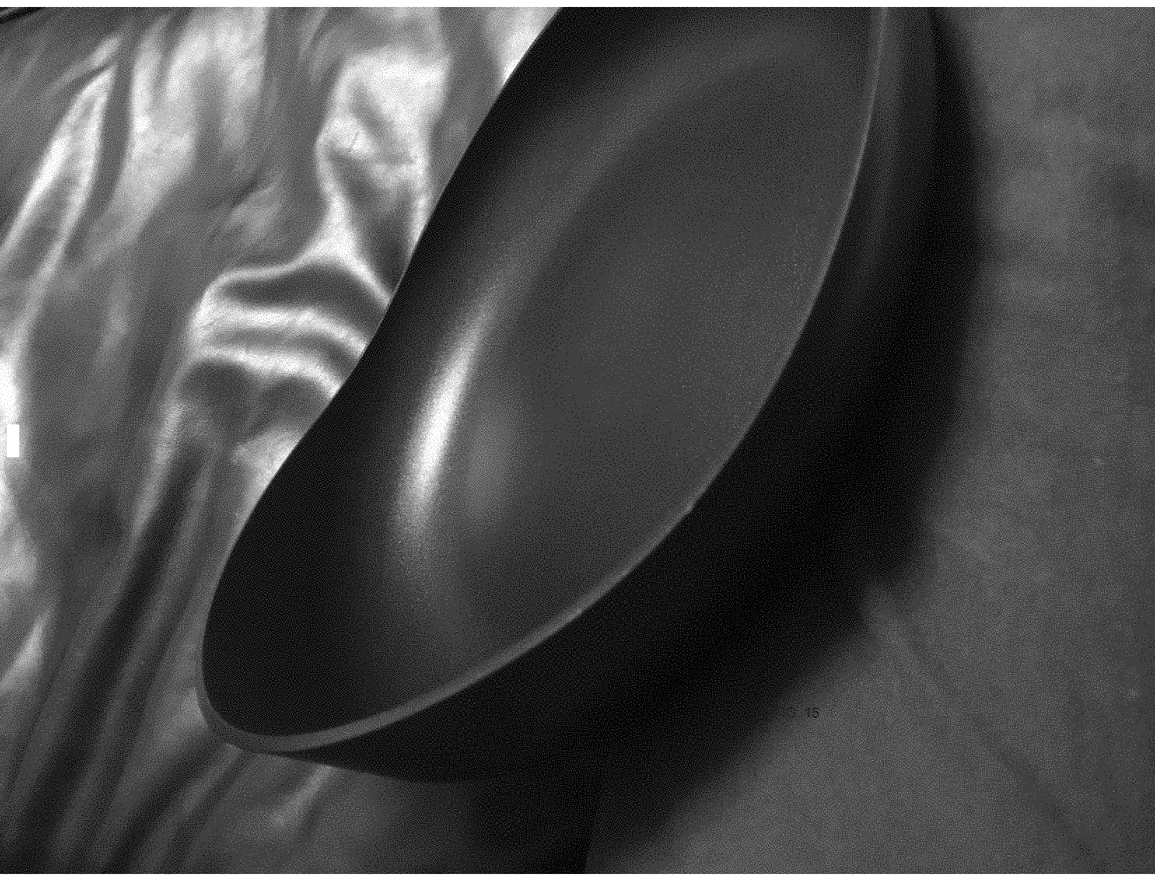

FIG. 15 is top perspective view of another embodiment of a pan.

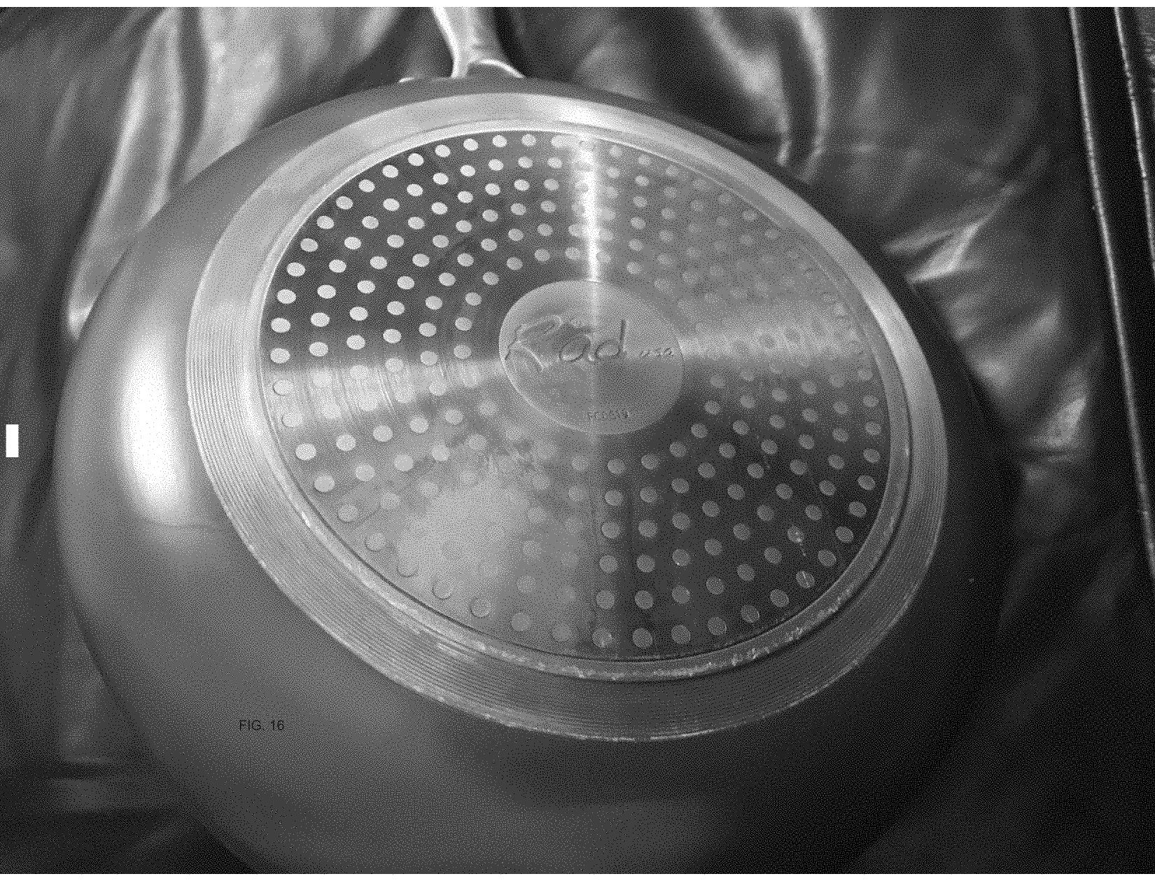

FIG. 16 is bottom perspective view of another embodiment of a pan.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit of the present disclosure. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A pan with an extended lip for tossing food in a controlled manner.
